(19) United States
(12) Patent Application Publication
(10) Pub. No.: US 2021/0329478 A1
(43) Pub. Date: Oct. 21, 2021

(54) RADIO WAVE STRENGTH ESTIMATION DEVICE, POSITION ESTIMATION SYSTEM, AND RADIO WAVE STRENGTH ESTIMATION METHOD

(71) Applicant: NEC Corporation, Tokyo (JP)

(72) Inventor: Yoshiaki NISHIKAWA, Tokyo (JP)

(73) Assignee: NEC Corporation, Tokyo (JP)

(21) Appl. No.: 17/229,050

(22) Filed: Apr. 13, 2021

(30) Foreign Application Priority Data
Apr. 16, 2020 (JP) 2020-073514

(51) Int. Cl. H04W 24/06; H04B 17/318

(52) U.S. Cl. CPC H04W 24/06; H04B 17/318

(57) ABSTRACT

A radio wave strength estimation device 30 includes: an acquisition unit 31 configured to, acquire first observed radio wave strength data for a signal that is received by each first observation apparatus whose positions is known; a simulated radio wave strength calculation unit 33 configured to calculate a simulated radio wave strength at each position in a target space for a simulation signal based on geospatial information on the target space; a learning unit 34 configured to learn a relation parameter indicating relation between radio wave strengths at respective first observation apparatus and that at a target position using the simulated radio wave strengths at the respective first observation apparatus and those at the target position; and a target radio wave strength calculation unit 35 configured to calculate a radio wave strength at the target position from the plurality of first observed radio wave strengths using the learned relation parameter.

### INCORPORATION BY REFERENCE

This application is based upon and claims the benefit of priority from Japanese patent application No. 2020-073514, filed on Apr. 16, 2020, the disclosure of which is incorporated herein in its entirety by reference.

### TECHNICAL FIELD

The present disclosure relates to a radio wave strength estimation device, a position estimation system, and a radio wave strength estimation method.

### BACKGROUND ART

A technique has been proposed that estimates received radio wave strengths in a target space, and estimates the position of a mobile terminal based on the estimated received radio wave strengths. For example, the position estimation apparatus disclosed in Japanese Unexamined Patent Application Publication No. 2017-067529 estimates the position of a mobile terminal by estimating the received power of a radio signal at each radio base station based on the distance, and searching a map for a position where its attenuation tendency matches the attenuation tendency of a received power measurement value acquired from each radio base station.

Here, as a method for estimating a received radio wave strength in a target space, a method using an observed value or observed amount measured by an observation apparatus is known. For example, a radio wave environment estimation apparatus disclosed in International Patent Publication No. WO2019/159965 estimates a radio wave strength in a floor based on relationship information between an input and an output that is learned using a combined reception strength calculated with layout information on the floor with the actual reception state information as labeled training information.

However, the above method disclosed in Japanese Unexamined Patent Application Publication No. 2017-067529 has a problem that the accuracy of estimating received power and the accuracy of estimating a position are insufficient because it is difficult to perform accurate simulation for estimating received power.

Further, in the above method disclosed in International Patent Publication No. WO2019/159965, many observation apparatuses need to be arranged in the target space in order to acquire training data, and therefore a large amount of apparatus cost and installation cost is needed. Further, there are uninstallable areas especially in factories and offices in operation, and therefore training data cannot be acquired sufficiently. For this reason, there is a problem that the accuracy of estimating a radio wave strength is insufficient.

### SUMMARY

In view of the above problems, an object of the present disclosure is to provide a radio wave strength estimation device, a position estimation system, and a radio wave strength estimation method that are capable of improving the accuracy of estimating a radio wave strength and improving the accuracy of estimating a position.

A radio wave strength estimation device according to an example aspect of the present disclosure includes:

at least one memory configured to store instructions; and

at least one processor configured to execute the instructions,

wherein the processor is configured to:

from each of a plurality of first observation apparatuses whose positions are known, acquire data on a first observed radio wave strength indicating a radio wave strength for a signal from a signal emission source that is received by each first observation apparatus;

calculate a simulated radio wave strength at each position in a target space for a simulation signal based on geospatial information on the target space using a theoretical model of radio wave propagation;

learn at least one relation parameter indicating relation between radio wave strengths at respective positions of the plurality of first observation apparatuses and a radio wave strength at a target position using the simulated radio wave strengths at the respective positions of the plurality of first observation apparatuses and the simulated radio wave strength at the target position; and

calculate a radio wave strength at the target position from the plurality of first observed radio wave strengths using the at least one learned relation parameter.

A position estimation system according to an example aspect of the present disclosure includes:

a radio wave strength estimation device; and

a position estimator, wherein

the radio wave strength estimation device includes:

at least one first memory configured to store instructions; and

at least one first processor configured to execute the instructions,

the first processor is configured to:

from each of a plurality of first observation apparatuses whose positions are known, acquire data on a first observed radio wave strength indicating a radio wave strength for a signal from a signal emission source that is received by each first observation apparatus;

calculate a simulated radio wave strength at each position in a target space for a simulation signal based on geospatial information on the target space using a theoretical model of radio wave propagation;

learn at least one relation parameter indicating relation between radio wave strengths at respective positions of the plurality of first observation apparatuses and a radio wave strength at a target position using the simulated radio wave strengths at the respective positions of the plurality of first observation apparatuses and the simulated radio wave strength at the target position; and

calculate a radio wave strength at the target position from the plurality of first observed radio wave strengths using the at least one learned relation parameter,

the position estimator includes:

at least one second memory configured to store instructions; and

at least one second processor configured to execute the instructions, and

the second processor is configured to acquire data on a second observed radio wave strength indicating a radio wave strength for a signal from the signal emission source that is received by a second observation apparatus whose position is unknown, and compare the second observed radio wave strength with the calculated radio wave strength at the target position to estimate the position of the second observation apparatus.

A radio wave strength estimation method according to an example aspect of the present disclosure includes:

a step of, from each of a plurality of first observation apparatuses whose positions are known, acquiring data on a first observed radio wave strength indicating a radio wave strength for a signal from a signal emission source that is received by each first observation apparatus;

a step of calculating a simulated radio wave strength at each position in a target space for a simulation signal based on geospatial information on the target space using a theoretical model of radio wave propagation;

a step of learning at least one relation parameter indicating relation between radio wave strengths at respective positions of the plurality of first observation apparatuses and a radio wave strength at a target position using the simulated radio wave strengths at the respective positions of the plurality of first observation apparatuses and the simulated radio wave strength at the target position; and

a step of calculating a radio wave strength at the target position from the plurality of first observed radio wave strengths using the at least one learned relation parameter.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram showing a configuration of a radio wave strength estimation device according to a first example embodiment;

FIG. 2 is a diagram showing an example configuration of a position estimation system according to a second example embodiment;

FIG. 3 is a block diagram showing an example configuration of a first observation apparatus according to the second example embodiment;

FIG. 4 is a block diagram showing an example configuration of a second observation apparatus according to the second example embodiment;

FIG. 5 is a block diagram showing an example configuration of a position estimation apparatus according to the second example embodiment;

FIG. 6 is a flowchart showing an example learning process in a radio wave strength estimation device according to the second example embodiment;

FIG. 7 is a diagram for describing the learning process in the radio wave strength estimation device according to the second example embodiment;

FIG. 8 is a flowchart showing an example process in the position estimation apparatus according to the second example embodiment;

FIG. 9 is a flowchart showing an example radio wave strength estimation process in the radio wave strength estimation device according to the second example embodiment;

FIG. 10 is a block diagram showing an example configuration of a position estimation apparatus according to a third example embodiment;

FIG. 11 is a flowchart showing an example learning process in a radio wave strength estimation device according to the third example embodiment;

FIG. 12 is a block diagram showing an example configuration of a position estimation apparatus according to a fourth example embodiment;

FIG. 13 is a diagram showing an example of display on a display unit of a radio wave strength estimation device according to the fourth example embodiment; and

FIG. 14 is a schematic configuration diagram of a computer according to the first to fourth example embodiments.

### EMBODIMENTS

Although the present disclosure will be described below through example embodiments, it is not intended to limit the disclosure according to Claims to the example embodiments below. Further, all of the configurations described in the example embodiments are not necessarily essential as means for solving the problems. In the drawings, the same elements are assigned the same reference numeral, and repeated description thereof will be omitted as necessary.

### First Example Embodiment

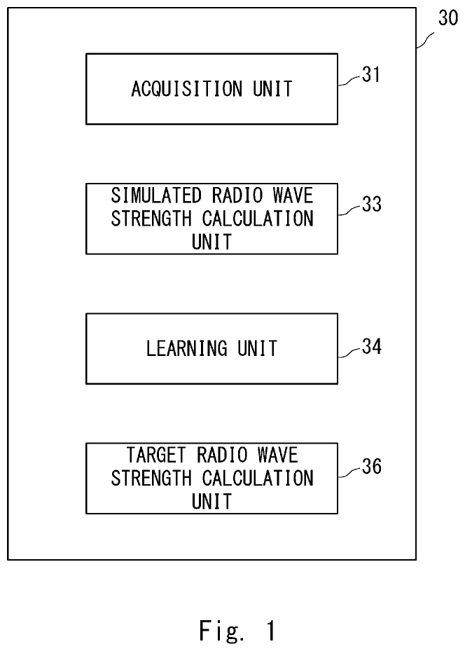

Hereinafter, a first example embodiment of the present disclosure will be described with reference to the drawings. FIG. 1 is a block diagram showing a configuration of a radio wave strength estimation device 30 according to the first example embodiment. The radio wave strength estimation device 30 includes an acquisition unit 31, a simulated radio wave strength calculation unit 33, a learning unit 34, and a target radio wave strength calculation unit 36.

From each of a plurality of first observation apparatuses whose positions are known, the acquisition unit 31 acquires data on a first observed radio wave strength indicating a radio wave strength for a signal from an emission source that is received by each first observation apparatus.

The simulated radio wave strength calculation unit 33 calculates a simulated radio wave strength at each position in a target space for a simulation signal based on geospatial information on the target space using a theoretical model of radio wave propagation.

The learning unit 34 learns at least one relation parameter using the simulated radio wave strengths at the respective positions of the plurality of first observation apparatuses and the simulated radio wave strength at a target position. Here, the relation parameter indicates relation between the radio wave strengths at the respective positions of the plurality of first observation apparatuses and the radio wave strength at the target position. Further, the target position indicates a position where a second observation apparatus 20 can be arranged in the target space.

The target radio wave strength calculation unit 36 calculates a radio wave strength at the target position from the plurality of first observed radio wave strengths using the at least one learned relation parameter.

Thus, according to the first example embodiment, the radio wave strength estimation device 30 learns the relation parameter using the result of simulation calculation based on the geospatial information, and calculates the radio wave strength at the target position using the learned relation parameter. Accordingly, the relation parameter is a parameter in which influences including relative positional relation between elements in the target space are reflected more faithfully, and the radio wave strength estimation device 30 can calculate a more accurate radio wave strength by applying actually measured radio wave strengths to this.

Further, since the radio wave strength estimation device 30 uses the result of simulation calculation as training data for the relation parameter, it can easily acquire training data even for a radio wave strength in an uninstallable area. This enables the radio wave strength estimation device 30 to improve the accuracy of estimating a radio wave strength. Furthermore, this enables the radio wave strength estimation device 30 to improve the estimation accuracy of the subsequent position estimation process.

### Second Example Embodiment

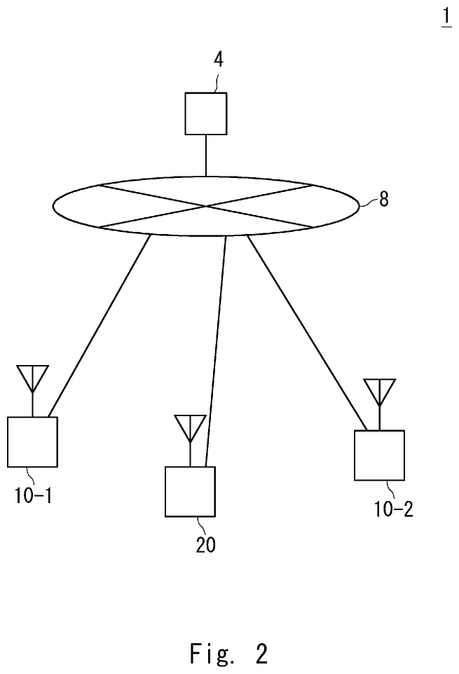

Next, a second example embodiment of the present disclosure will be described using FIGS. 2-9. FIG. 2 is a diagram showing an example configuration of a position estimation system 1 according to the second example embodiment. The position estimation system 1 is a system that estimates the position of an observation apparatus whose position is unknown in the target space.

Here, the target space is a spatial area in which the position estimation system 1 is to estimate a position, and may be a predetermined outdoor or indoor area. As an example, the target space may be an area in a factory or a floor in a building such as an office.

The position estimation system 1 includes a plurality of first observation apparatuses 10-1 and 10-2, the second observation apparatus 20, and a position estimation apparatus 4, and is configured so that they are communicably connected via a network 8. Hereinafter, when the first observation apparatuses 10-1 and 10-2 are referred to without distinction, the first observation apparatuses 10-1 and 10-2 may simply be referred to as first observation apparatuses 10. Note that although the number of the first observation apparatuses 10 and the number of the second observation apparatuses 20 included in the position estimation system 1 are here set to two and one, respectively, for simplicity of explanation, the present disclosure is not limited thereto.

The network 8 is configured to include various networks such as the Internet, a wide area network (WAN), and a local area network (LAN), or a combination thereof. Further, the network 8 may include a dedicate line separate from the Internet. Note that the network 8 is the Internet in this second example embodiment.

The first observation apparatuses 10 are observation apparatuses such as computers whose positions are known. The first observation apparatuses 10 are installed at predetermined positions in the target space.

Each first observation apparatus 10 receives a predetermined signal transmitted by radio from a signal emission source (not shown), and measures a radio wave strength for the received predetermined signal. Here, a radio wave strength measured by the first observation apparatus 10 is referred to as a first observed radio wave strength. Thereby, each first observation apparatus 10 obtains data on the first observed radio wave strength (first observed radio wave strength data). Then, each first observation apparatus 10 transmits the first observed radio wave strength data to the position estimation apparatus 4.

On the other hand, the second observation apparatus 20 is an observation apparatus such as a computer whose position is unknown. As an example, the second observation apparatus 20 may be a mobile terminal such as a mobile phone, a smartphone, or a tablet terminal. That is, the position estimation system 1 is a system that estimates the position of the second observation apparatus 20.

The second observation apparatus 20 receives the predetermined signal transmitted by radio from the signal emission source, and measures a radio wave strength for the received predetermined signal. Here, a radio wave strength measured by the second observation apparatus 20 is referred to as a second observed radio wave strength. Thereby, the second observation apparatus 20 obtains data on the second observed radio wave strength (second observed radio wave strength data). Then, the second observation apparatus 20 transmits the second observed radio wave strength data to the position estimation apparatus 4.

Note that the first observation apparatuses 10 and the position estimation apparatus 4 as well as the second observation apparatus 20 and the position estimation apparatus 4 may be connected by wire to each other, or may be connected by radio to each other.

The position estimation apparatus 4 is a computer such as a server computer. The position estimation apparatus 4 acquires the first observed radio wave strength data from each first observation apparatus 10, and estimates radio wave strengths in the target space based on the first observed radio wave strength. Then, the position estimation apparatus 4 acquires the second observed radio wave strength data from the second observation apparatus 20, and estimates the position of the second observation apparatus 20 based on the estimated radio wave strengths in the target space and the second observed radio wave strength.

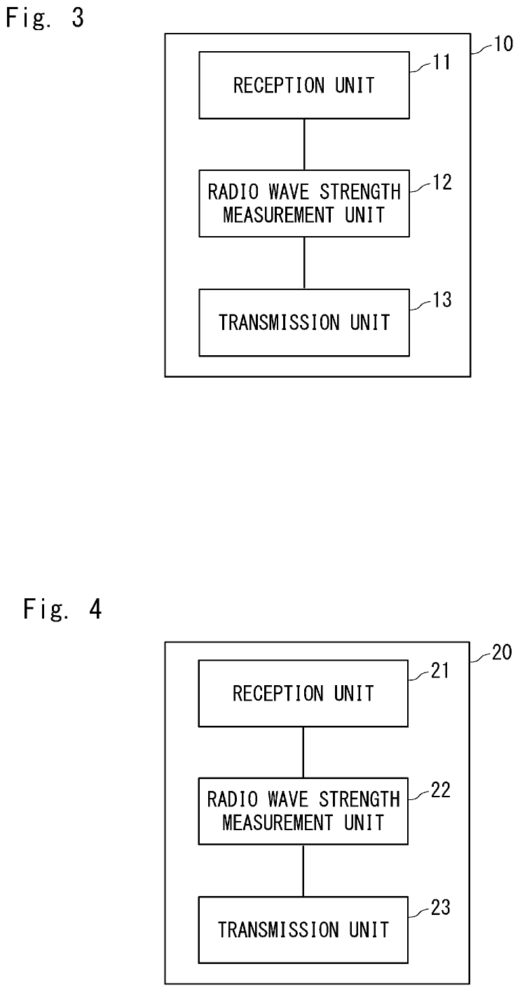

FIG. 3 is a block diagram showing an example configuration of the first observation apparatus 10 according to the second example embodiment. As shown in FIG. 3, the first observation apparatus 10 includes a reception unit 11, a radio wave strength measurement unit 12, and a transmission unit 13.

The reception unit 11 receives a plurality of predetermined signals transmitted by radio from the signal emission source.

The radio wave strength measurement unit 12 measures (observes) the “radio wave strengths” of the predetermined signals received by the reception unit 11 to obtain the first observed radio wave strength data.

Here, a “radio wave strength” is generally determined by transmission power, reception sensitivity, and communication environment between a transmitter and a receiver. Examples of communication environment between a transmitter and a receiver include a distance, multipath, shielding, and fading. The upper limit of an observed value of radio wave strength is considered to be determined from these pieces of information, and generally decreases as the distance between a transmitter and a receiver increases. The lower limit of an observed value of radio wave strength generally depends on the performance limit of an observation apparatus. An observed value of radio wave strength stochastically appears between these upper and lower limits.

The transmission unit 13 transmits the first observed radio wave strength data obtained by the radio wave strength measurement unit 12 to the position estimation apparatus 4.

FIG. 4 is a block diagram showing an example configuration of the second observation apparatus 20 according to the second example embodiment. As shown in FIG. 4, the second observation apparatus 20 includes a reception unit 21, a radio wave strength measurement unit 22, and a transmission unit 23.

The reception unit 21 receives the predetermined signal transmitted by radio from the signal emission source.

The radio wave strength measurement unit 22 measures (observes) the “radio wave strength” of the predetermined signal received by the reception unit 21. Thereby, the radio wave strength measurement unit 22 obtains the second observed radio wave strength data.

The transmission unit 23 transmits the second observed radio wave strength data obtained by the radio wave strength measurement unit 22 to the position estimation apparatus 4.

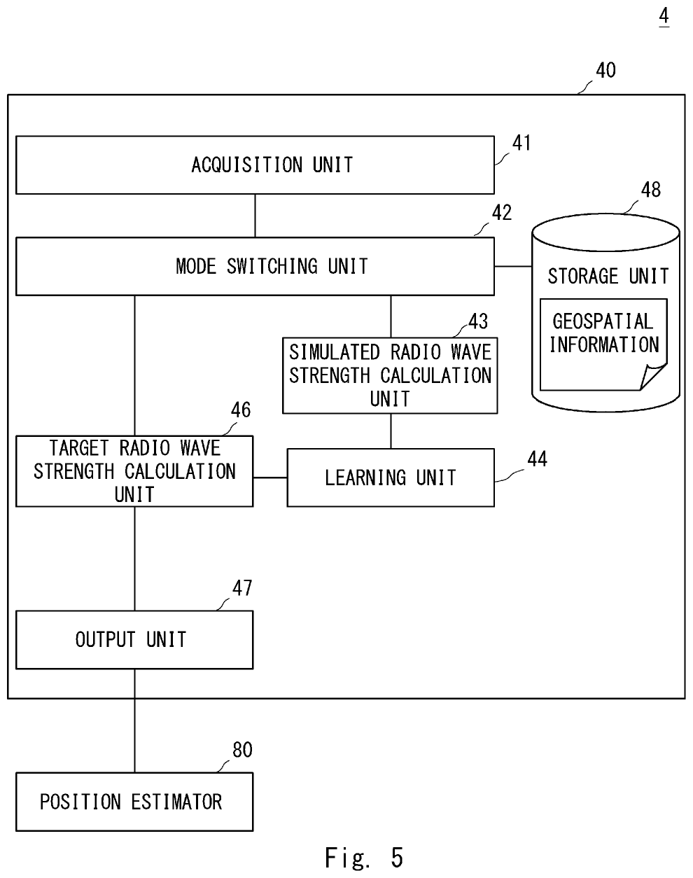

FIG. 5 is a block diagram showing an example configuration of the position estimation apparatus 4 according to the second example embodiment. The position estimation apparatus 4 includes a radio wave strength estimation device 40 and a position estimator 80.

The radio wave strength estimation device 40 is a computer or the like that estimates radio wave strengths in the target space based on the first observed radio wave strength. The radio wave strength estimation device 40 has an acquisition unit 41, a mode switching unit 42, a simulated radio wave strength calculation unit 43, a learning unit 44, a target radio wave strength calculation unit 46, an output unit 47, and a storage unit 48.

The acquisition unit 41 receives and acquires the first observed radio wave strength data from each of the plurality of first observation apparatuses 10. Further, the acquisition unit 41 may receive and acquire the second observed radio wave strength data from the second observation apparatus 20. The acquisition unit 41 stores the acquired first or second observed radio wave strength data in the storage unit 48 via the mode switching unit 42. However, without being limited thereto, the acquisition unit 41 may supply the acquired first observed radio wave strength data to the target radio wave strength calculation unit 46 via the mode switching unit 42, and supply the acquired second observed radio wave strength data to the output unit 47 via the mode switching unit 42.

The mode switching unit 42 selects a processing mode, and makes a switch to the selected processing mode. Then, the mode switching unit 42 performs mode switching control on various components of the radio wave strength estimation device 40 according to the processing mode. Here, processing modes include an “estimation mode” and a “learning mode”. In response to the “estimation mode” being selected, the mode switching unit 42 supplies the first observed radio wave strength data stored in the storage unit 48 to the target radio wave strength calculation unit 46, and performs mode switching control on the target radio wave strength calculation unit 46. Further, in response to the “learning mode” being selected, the mode switching unit 42 supplies the geospatial information stored in the storage unit 48 to the simulated radio wave strength calculation unit 43, and performs mode switching control on the simulated radio wave strength calculation unit 43 and the learning unit 44. Details of the geospatial information will be described later. Note that the mode switching unit 42 may be connected to an input unit (not shown) that receives an input from a user, and select a mode according to the input from the user.

In response to being switched to the “learning mode”, the simulated radio wave strength calculation unit 43 calculates the simulated radio wave strength at each position in the target space for the simulation signal based on the geospatial information on the target space using the theoretical model of radio wave propagation.

Here, the geospatial information is geographical spatial information on the target space. As an example, the geospatial information includes the area size and shape of the target space, position information on the signal emission source, position information on the first observation apparatuses 10, and position information on a structure that reflects or shields radio waves included in the target space. As an example, the structure may be a wall, a door, a window, or any other structure on the floor. The position information on the first observation apparatuses 10 and the structure may be relative position information to the signal emission source. Note that the geospatial information may include the size, shape, material, and the like of the structure in addition to them. Further, the positions in the target space include the installation positions of the first observation apparatuses 10.

In this second example embodiment, the simulated radio wave strength calculation unit 43 employs a simulation model using a ray tracing approach as the theoretical model of radio wave propagation, and calculates a simulated radio wave strength using this model. However, without being limited thereto, the theoretical model of radio wave propagation may be any other theoretical model.

The simulated radio wave strength calculation unit 43 supplies data on the calculated simulated radio wave strength at each position to the learning unit 44.

When being switched to the “learning mode”, the learning unit 44 learns the relation parameter of a prediction model using the simulated radio wave strengths at the respective installation positions of the plurality of first observation apparatuses 10 and the simulated radio wave strength at the target position.

Here, the prediction model is a model that expresses the radio wave strength at any position (which is the target position here) in the target space using the radio wave strengths at the installation positions of the first observation apparatuses 10. That is, when any position is input, the prediction model in the “learning mode” outputs the simulated radio wave strength at the input position using the simulated radio wave strengths at the installation positions of the first observation apparatuses 10 calculated by the simulated radio wave strength calculation unit 43.

Then, the relation parameter is a parameter indicating relation between the radio wave strengths at the respective positions of the plurality of first observation apparatuses 10 and the radio wave strength at the target position. That is, the prediction model expresses the radio wave strength at the target position using the relation parameter and the radio wave strengths at the respective positions of the plurality of first observation apparatuses 10. The relation parameter depends on the prediction model, and indicates a series of numerical values that should be determined in advance when performing calculation according to the prediction model.

As an example, the prediction model may output the radio wave strength at the input position by performing addition, subtraction, multiplication, or division of a constant corresponding to the input position on the radio wave strengths at the installation positions of the first observation apparatuses 10. In this case, the relation parameter indicates the constant for addition, subtraction, multiplication, or division. Further, the prediction model may output the radio wave strength at the input position by calculating the weighted average of the radio wave strengths at the installation positions of the plurality of first observation apparatuses 10 with weights corresponding to the input position. In this case, the relation parameter indicates the weights for weighted average.

Note that learning the relation parameter indicates a process of determining the value of the relation parameter using some kind of data. Details of this process will be described later.

The learning unit 44 repeats these processes for each position in the target space to obtain the learned relation parameter for each position in the target space.

In response to being switched to the “estimation mode”, the target radio wave strength calculation unit 46 calculates the radio wave strength at the target position from the plurality of first observed radio wave strengths using the prediction model including the learned relation parameter supplied from the learning unit 44. In this second example embodiment, the target radio wave strength calculation unit 46 calculates the radio wave strength at each position from the plurality of first observed radio wave strengths using the prediction model including the learned relation parameters for the positions including the target position in the target space.

The output unit 47 outputs the radio wave strength at the target position supplied from the target radio wave strength calculation unit 46. In this second example embodiment, the output unit 47 outputs the radio wave strengths at the positions including the target position in the target space supplied from the target radio wave strength calculation unit 46 to the position estimator 80 together with the second observed radio wave strength supplied from the mode switching unit 42.

The storage unit 48 is a storage medium that stores various types of information used for the processes in the “learning mode” and the “estimation mode” and the position estimation process. That is, the storage unit 48 stores the geospatial information used for the process in the “learning mode”. Further, the storage unit 48 may store the first observed radio wave strength data used for the “estimation mode”. Furthermore, the storage unit 48 may store the second observed radio wave strength data used for the position estimation process.

The position estimator 80 acquires the data on the second observed radio wave strength and the data on the radio wave strength at the target position calculated by the target radio wave strength calculation unit 46 from the output unit 47 of the radio wave strength estimation device 40. Then, the position estimator 80 compares the second observed radio wave strength with the radio wave strength at the target position calculated by the target radio wave strength calculation unit 46 to estimate the position of the second observation apparatus 20.

Note that when a plurality of signal emission sources are arranged in the target space, a “radio wave strength” and a “simulated radio wave strength” in the above description are replaced with a “radio wave strength vector” and a “simulated radio wave strength vector”, respectively.

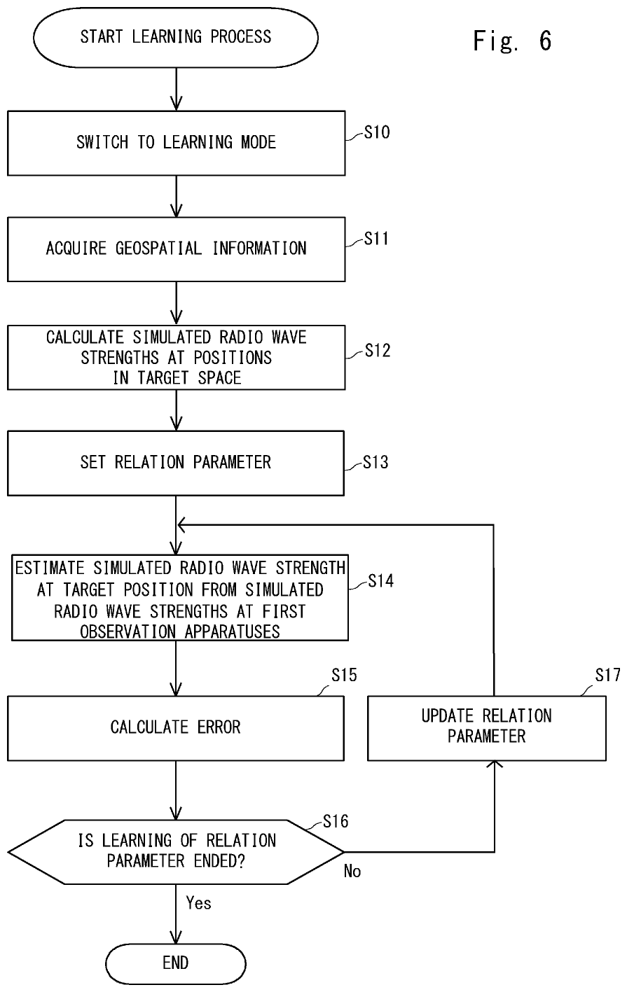

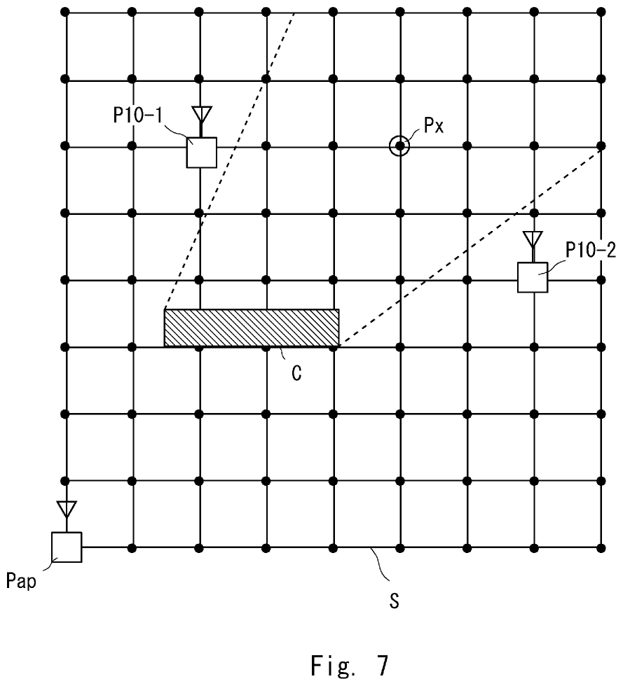

Next, a learning process in the “learning mode” in the radio wave strength estimation device 40 of the position estimation apparatus 4 will be described using FIG. 6 with reference to FIG. 7. FIG. 6 is a flowchart showing an example learning process in the radio wave strength estimation device 40 according to the second example embodiment. Further, FIG. 7 is a diagram for describing the learning process in the radio wave strength estimation device 40 according to the second example embodiment. Note that a learning process of the relation parameter for the target position in the case where the number of the first observation apparatuses 10 installed in the target space is two (N=2) will be described below as an example for simplification of explanation.

First, in step S10, the mode switching unit 42 selects the “learning mode” as the processing mode, and switches the processing mode to the “learning mode”. Then, the mode switching unit 42 supplies the geospatial information on the target space stored in the storage unit 48 to the simulated radio wave strength calculation unit 43.

Next, in step S11, the simulated radio wave strength calculation unit 43 acquires the geospatial information on the target space.

Next, in step S12, the simulated radio wave strength calculation unit 43 calculates the simulated radio wave strength for each position in the target space using the theoretical model of radio wave propagation (the simulation model). Here, a specific example of calculating the simulated radio wave strengths will be described using FIG. 7.

As shown in FIG. 7, the simulated radio wave strength calculation unit 43 first defines the target space on the simulation model based on the geospatial information. The simulated radio wave strength calculation unit 43 defines a two-dimensional coordinate system for the target space based on the area size and shape of the target space included in the geospatial information, for example, defines a quadrilateral area S. That is, the quadrilateral area S corresponds to the target space on the simulation model. Then, the simulated radio wave strength calculation unit 43 partitions the quadrilateral area S in a lattice form, and defines each point on the lattice as a point where the first observation apparatuses 10 or the second observation apparatus 20 may be arranged on the simulation model.

Then, the simulated radio wave strength calculation unit 43 sets the position of the signal emission source (also referred to as the transmission position) from among the points included in the quadrilateral area S based on the position information on the signal emission source included in the geospatial information. In FIG. 7, the transmission position on the quadrilateral area S is Pap.

Further, the simulated radio wave strength calculation unit 43 defines a structure C in the quadrilateral area S based on the position information, size, shape, material, and the like of the structure included in the geospatial information.

Further, the simulated radio wave strength calculation unit 43 selects the point corresponding to the target position (also referred to as the reception position) from among the points included in the quadrilateral area S. In FIG. 7, the point corresponding to the target position is Px.

Then, the simulated radio wave strength calculation unit 43 sets various parameters used for the simulation model, and calculates the simulated radio wave strength at Px in the quadrilateral area S.

Here, radio waves propagate from the transmission position to the reception position through a plurality of routes while being reflected and transmitted. The routes of radio waves between the transmission position and the reception position can be determined using the geospatial information. It is considered that the accurate radio wave strength can be calculated by appropriately setting the parameters of the simulation model in each route. The parameters of the simulation model may be the distance between the transmission position and the reception position, the number of reflections, the number of transmissions, a reflection coefficient, a transmission coefficient, an attenuation coefficient according to the distance, transmission power, the directivity of transmission and reception, and any other parameters.

In this second example embodiment, the simulated radio wave strength calculation unit 43 repeats simulation calculation for each position in the target space, that is, for each point in the quadrilateral area S to obtain the simulated radio wave strength at each position. Then, the simulated radio wave strength calculation unit 43 supplies the data on the simulated radio wave strength at each position in the target space to the learning unit 44.

Note that the simulated radio wave strength calculation unit 43 can grasp the points corresponding to the installation positions of the first observation apparatuses 10 in the target space on the simulation model using the position information on the first observation apparatuses 10 included in the geospatial information. As shown in FIG. 7, the installation position of the first observation apparatus 10-1 is P10-1 on the quadrilateral area S, and the installation position of the first observation apparatus 10-2 is P10-2 on the quadrilateral area S. Accordingly, the simulated radio wave strength calculation unit 43 outputs the data on the simulated radio wave strengths at P10-1 and P10-2 and the data on the simulated radio wave strengths at the other points to the learning unit 44.

Then, in step S13, the learning unit 44 sets the relation parameter of the prediction model to a predetermined value.

In step S14, the learning unit 44 estimates the simulated radio wave strength at the target position from the simulated radio wave strengths at the installation positions of the first observation apparatuses 10 using the prediction model in which the relation parameter is set.

Here, in this example, the prediction model that estimates the simulated radio wave strength at the target position Px in the “learning mode” is expressed using the simulated radio wave strengths (yₚ₁, yₚ₂) at the installation positions of the first observation apparatuses 10 as follows:

y_{P}(x)=w_{P(x)}yₚ₁+(1−w_{P(x)})yₚ₂ [Expression 1]

Here, P(x) denotes the position coordinate of the target position Px in the target space, and p1 and p2 denote the position coordinates of P10-1 and P10-2 in the target space, respectively. Further, y_{P(x)} is an estimate of the simulated radio wave strength at the target position Px, and yₚ₁ and yₚ₂ are the simulated radio wave strengths at P10-1 and P10-2, respectively. Then, wₚ₍ₓ₎ is the relation parameter set for the target position Px. Thus, the relation parameter in this example is expressed using the radio wave strengths at the respective positions P10-1 and P10-2 of the two first observation apparatuses 10-1 and 10-2 arranged at different positions and the radio wave strength at the target position Px.

The learning unit 44 inputs the simulated radio wave strengths yₚ₁ and yₚ₂ at the installation positions of the first observation apparatuses 10 to this prediction model in which the relation parameter is set, thereby calculating an estimate y_{P(x)} of the simulated radio wave strength at the target position.

Next, in step S15, the learning unit 44 calculates an error between the simulated radio wave strength at the target position calculated by the simulated radio wave strength calculation unit 43 in step S12 and the estimate of the simulated radio wave strength at the target position estimated by the learning unit 44 in step S14. In this example, the learning unit 44 calculates an error between the simulated radio wave strength at the target position calculated by the simulated radio wave strength calculation unit 43 and the estimate y_{P(x)} based on the prediction model.

Next, in step S16, the learning unit 44 determines whether to end the learning of the relation parameter. For example, the learning unit 44 may determine whether to end the learning by determining whether the error is smaller than a predetermined threshold. Further, the learning unit 44 may determine whether to end the learning by determining whether the number of updates has reached a predetermined number of times. The learning unit 44 ends the process when having determined to end the learning (Yes in step S16), or advances the processing to step S17 otherwise (No in step S16).

In step S17, the learning unit 44 updates the relation parameter based on the error. Then, the learning unit 44 returns the processing to step S14.

Note that when learning the relation parameter for each position in the target space, the learning unit 44 repeats the processes shown in steps S13-S17 for each position in the target space.

Further, in this second example embodiment, as an example, in steps S13-S17, the learning unit 44 determines the relation parameter based on the error between the simulation calculation result based on the theoretical model and the estimate based on the prediction model. However, without being limited thereto, the learning unit 44 may find the solution by transforming the prediction model with respect to the relation parameter, or may calculate an appropriate value of the relation parameter using regression. Further, the learning unit 44 may determine the value of the relation parameter using other approaches such as machine learning.

Note that although the target space on the simulation model is a two-dimensional coordinate system in FIG. 7 as an example, the target space on the simulation model may be a three-dimensional coordinate system.

Although a learning process in the case where the number of the first observation apparatuses 10 installed in the target space is two (N=2) has been described above as an example, the number of the first observation apparatuses 10 installed in the target space may be N (N>2). At this time, the learning unit 44 learns the relation parameter that is set for the target position in correspondence with each of the installation positions of the first observation apparatuses 10.

In this case, as an example, the prediction model that estimates the simulated radio wave strength at the target position Px in the “learning mode” is expressed using the simulated radio wave strengths yₚₖ, k=(1, 2, . . . , N) at the installation positions P10-k of the N first observation apparatuses 10 as follows:

$${y}_{P ( x )} = {\sum }_{1 \leq k \leq N} {w}_{P ( x ) , {p}_{k}} {y}_{{p}_{k}} . \qquad [ Expression 2 ]$$

Here, w_{p(x), pk} is the relation parameter that is set for the target position Px in correspondence with P10-k. That is, w_{p(x), pk} denotes a weight at the target position Px for the radio wave strength yₚₖ at P10-k.

Accordingly, in step S14, the learning unit 44 inputs the simulated radio wave strengths yₚₖ at the installation positions of the first observation apparatuses 10 to this prediction model in which each relation parameter is set, thereby calculating an estimate yₚ₍ₓ₎ of the simulated radio wave strength at the target position.

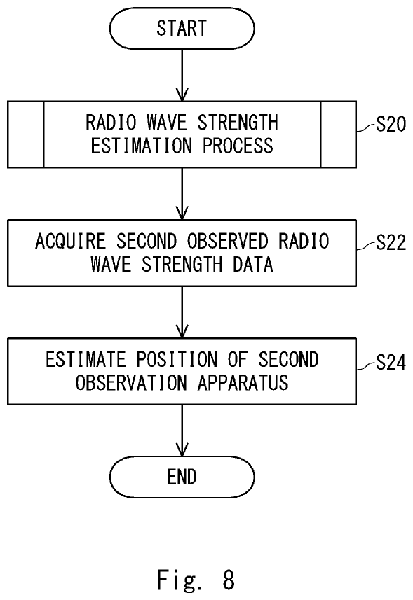

Next, a process in the position estimation apparatus 4 will be described using FIG. 8. FIG. 8 is a flowchart showing an example process in the position estimation apparatus 4 according to the second example embodiment.

First, in step S20, the radio wave strength estimation device 40 of the position estimation apparatus 4 executes a radio wave strength estimation process to estimate the radio wave strength at each position in the target space.

Next, in step S22, the position estimator 80 in the position estimation apparatus 4 acquires the second observed radio wave strength data from the second observation apparatus 20 via the acquisition unit 41 of the radio wave strength estimation device 40.

Next, in step S24, the position estimator 80 compares the second observed radio wave strength with the radio wave strength at each position in the target space output from the output unit 47 of the radio wave strength estimation device 40 to estimate the position of the second observation apparatus 20. At this time, the position estimator 80 may compare the second observed radio wave strength with the radio wave strength at each position in the target space to identify a position where the matching degree or similarity degree is the highest as the position of the second observation apparatus 20. Here, the position estimator 80 may identify a position where the square error of received power is the lowest as the position where the matching degree is the highest. Note that when a plurality of signal emission sources are arranged in the target space, the position estimator 80 may identify a position where the sum of the square errors of received power for the respective signal emission sources is the lowest as the position where the matching degree is the highest.

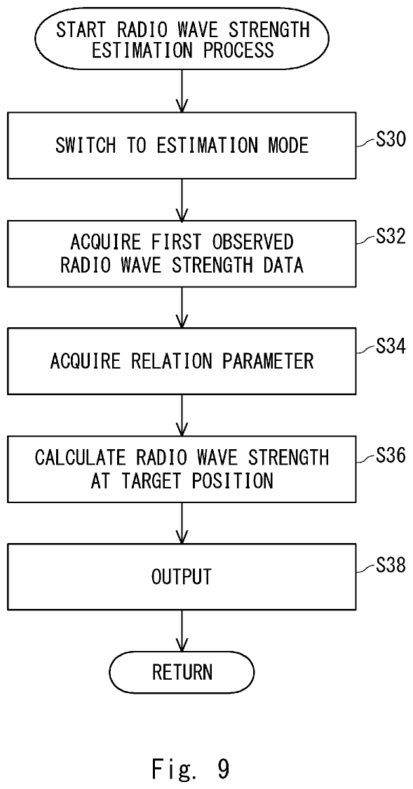

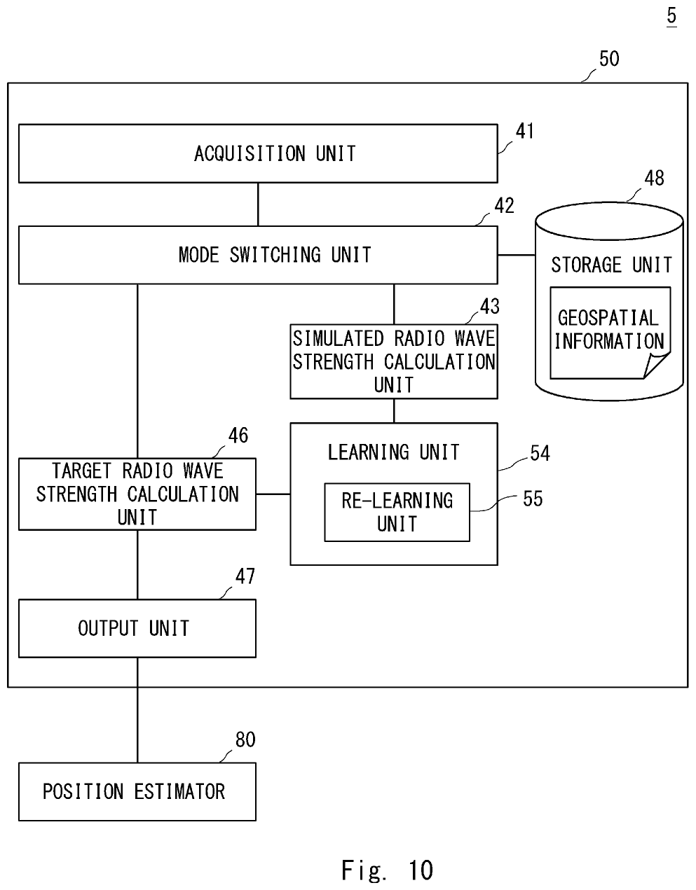

Next, the radio wave strength estimation process in the radio wave strength estimation device 40 shown in step S20 of FIG. 8 will be described using FIG. 9. FIG. 9 is a flowchart showing an example radio wave strength estimation process in the radio wave strength estimation device 40 according to the second example embodiment.

First, in step S30, the mode switching unit 42 selects the “estimation mode” as the processing mode, and switches the processing mode to the “estimation mode”. Then, the mode switching unit 42 supplies the first observed radio wave strength data stored in the storage unit 48 and a mode switching control signal to the target radio wave strength calculation unit 46.

Next, in step S32, the target radio wave strength calculation unit 46 acquires the first observed radio wave strength data.

Next, in step S34, the target radio wave strength calculation unit 46 acquires the relation parameter for the target position included in the prediction model from the learning unit 44.

Next, in step S36, the target radio wave strength calculation unit 46 calculates the radio wave strength at the target position based on the first observed radio wave strengths, which are actually measured values of the radio wave strengths at the installation positions of the first observation apparatuses 10, and the relation parameter using the prediction model.

Here, as an example in the case where the number of the first observation apparatuses 10 installed in the target space is two (N=2), the prediction model is expressed in the “estimation mode” as follows:

z_{P(x)}=w_{P(x)}zₚ₁+(1−w_{P(x)})zₚ₂ [Expression 3]

Here, zₚ₍ₓ₎ is the radio wave strength at the target position Px, and zₚ₁ and zₚ₂ are the first observed radio wave strengths at the first observation apparatuses 10-1 and 10-2, respectively. Then, w_{P(x)} is the learned relation parameter set for the target position Px.

Note that as an example in the case where the number of the first observation apparatuses 10 installed in the target space is N (N>2), the prediction model is expressed in the “estimation mode” as follows:

$${z}_{P ( x )} = {\sum }_{1 \leq k \leq N} {w}_{P ( x ) , {p}_{k}} {z}_{{p}_{k}} . \qquad [ Expression 4 ]$$

Here, zₚₖ; k=(1, 2, . . . , N) is the first observed radio wave strength at the first observation apparatus 10-k. Then, w_{P(x), pk} is the learned relation parameter that is set for the target position Px in correspondence with P10-k.

Next, in step S38, the output unit 47 outputs the data on the radio wave strength at the target position to the position estimator 80. Then, the output unit 47 returns the processing to step S22 shown in FIG. 8.

Note that when calculating the radio wave strength for each position in the target space, the target radio wave strength calculation unit 46 repeats the process shown in step S36 for each position in the target space. Then, in step S38, the output unit 47 outputs the data on the radio wave strength at each position in the target space to the position estimator 80.

Further, when a plurality of signal emission sources are arranged in the target space, the radio wave strength estimation device 40 learns the relation parameter for any position for each of the plurality of signal emission sources. Then, the radio wave strength estimation device 40 calculates the radio wave strength at any position for each of the plurality of signal emission sources. This enables the radio wave strength estimation device 40 to obtain a radio wave strength vector at any position whose elements are the radio wave strengths calculated for respective signal emission sources.

Thus, according to the second example embodiment, the radio wave strength estimation device 40 learns the relation parameter using the result of simulation calculation based on the geospatial information including the position information on the structure, and calculates the radio wave strength at the target position using the learned relation parameter. That is, the relation parameter is a parameter in which influences including relative positional relation between elements such as the structure and the transmission and reception positions in the target space are reflected more faithfully. Accordingly, the radio wave strength estimation device 40 can calculate a more accurate radio wave strength by applying actually measured radio wave strengths to this.

Further, since the radio wave strength estimation device 40 uses the result of simulation calculation as training data for the relation parameter, it can easily obtain training data even for a radio wave strength in an uninstallable area. This enables the radio wave strength estimation device 40 to improve the accuracy of estimating a radio wave strength. Furthermore, this enables the radio wave strength estimation device 40 to improve the estimation accuracy of the position estimation process in the position estimator 80.

Further, when the number of the first observation apparatuses 10 is small (e.g., N=2), it is possible to easily estimate a radio wave strength in an area where no observation apparatus is installed while suppressing the apparatus cost and installation cost of observation apparatuses.

### Third Example Embodiment

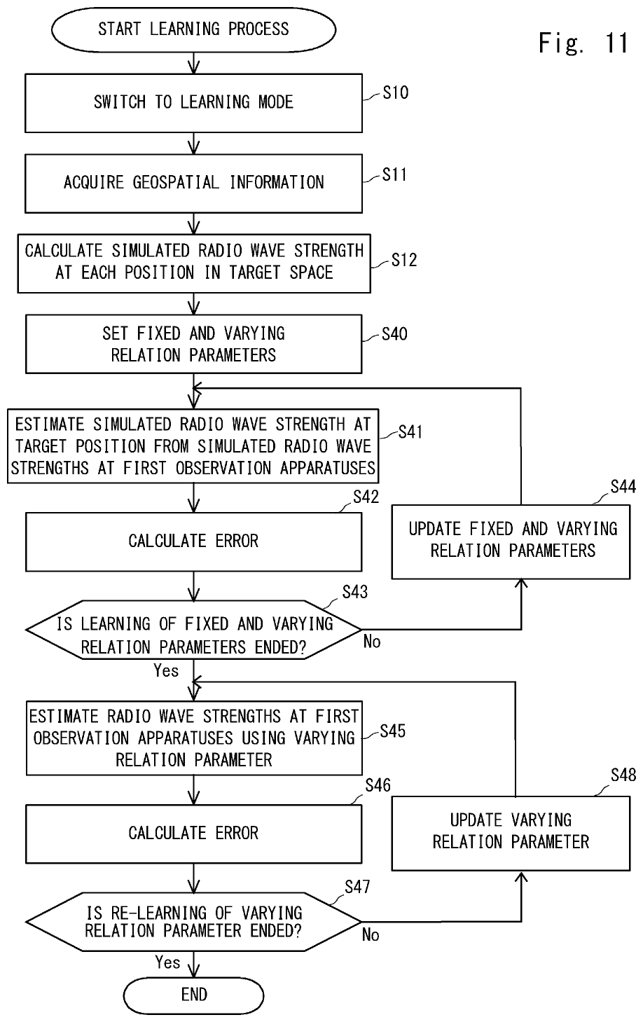

Next, a third example embodiment of the present disclosure will be described using FIGS. 10-11. The third example embodiment is characterized in that relation parameters include a parameter that varies according to actually measured values of radio wave strength (a varying relation parameter). That is, in the third example embodiment, the relation parameters include a varying relation parameter that varies according to the plurality of first observed radio wave strengths.

FIG. 10 is a block diagram showing an example configuration of a position estimation apparatus 5 according to the third example embodiment. The position estimation apparatus 5 according to the third example embodiment basically has the same configuration and function as those of the position estimation apparatus 4 according to the second example embodiment. However, the position estimation apparatus 5 according to the third example embodiment is different from the position estimation apparatus 4 according to the second example embodiment in that it includes a radio wave strength estimation device 50 instead of the radio wave strength estimation device 40.

The radio wave strength estimation device 50 basically has the same configuration and function as those of the radio wave strength estimation device 40. However, the radio wave strength estimation device 50 has a learning unit 54 instead of the learning unit 44.

When being switched to the “learning mode”, the learning unit 54 learns the relation parameters of the prediction model using the simulated radio wave strengths as in the learning unit 44. Here, the relation parameters include a fixed relation parameter that is not affected by the first observed radio wave strengths and a varying relation parameter that varies according to the first observed radio wave strengths. That is, the fixed relation parameter is a parameter that can be learned only using the simulated radio wave strength at any position calculated by the simulated radio wave strength calculation unit 43. On the other hand, the varying relation parameter is a parameter that is not only learned using the simulated radio wave strengths but can be adjusted using the data from the actually installed observation apparatuses. Accordingly, the learning unit 54 learns the varying relation parameter and the fixed relation parameter using the simulated radio wave strengths. Then, the learning unit 54 further includes a re-learning unit 55.

Using the plurality of first observed radio wave strengths, the re-learning unit 55 re-learns the varying relation parameter included in the relation parameters that have been learned using the simulated radio wave strengths.

Note that again in this third example embodiment, when a plurality of signal emission sources are arranged in the target space, a “radio wave strength” and a “simulated radio wave strength” in the above description are replaced with a “radio wave strength vector” and a “simulated radio wave strength vector”, respectively.

FIG. 11 is a flowchart showing an example learning process in the radio wave strength estimation device 50 according to the third example embodiment. Steps shown in FIG. 11 include steps S40-48 instead of steps S13-17 shown in FIG. 6. The same step as a step shown in FIG. 6 is assigned the same symbol, and description thereof will be omitted.

In response to the simulated radio wave strength calculation unit 43 calculating the simulated radio wave strengths in step S12, the learning unit 54 sets the fixed and varying relation parameters of the prediction model to predetermined values in step S40.

Next, in step S41, the learning unit 54 estimates the simulated radio wave strength at the target position from the simulated radio wave strengths at the installation positions of the first observation apparatuses 10 using the prediction model in which the fixed and varying relation parameters are set.

Here, in this example, the simulated radio wave strengths yₚₖ at the installation positions pₖ; k=(1, 2, . . . , N) of the first observation apparatuses 10 are modeled in the “learning mode” as follows:

yₚ_{ₖ}=txₐₚ−aₚ_{ₖ}D(pₖ,P(ap)) [Expression 5]

Here, txₐₚ is transmission power of the signal emission source ap, and aₚₖ is attenuated power per unit distance at the first observation apparatus located at the position pₖ. Note that txₐₚ and aₚₖ are varying relation parameters. D( ) is a function with respect to a distance between arguments.

Further, in this example, the prediction model that estimates the simulated radio wave strength at the target position Px is expressed in the “learning mode” using the simulated radio wave strengths yₚₖ at the installation positions pₖ; k=(1, 2, . . . , N) of the first observation apparatuses 10 as follows:

$${y}_{P ( x )} = {tx}_{ap} - {\sum }_{1 \leq k \leq N} {a}_{{p}_{k}} {b}_{P ( x ) , {p}_{k}} D ( P ( x ) , P ( ap ) ) . \qquad [ Expression 6 ]$$

Here, yₚ₍ₓ₎ is an estimate of the simulated radio wave strength at the target position Px. Further, b_{p(x), pk} is a fixed relation parameter indicating a weight at the position P(x) for the attenuated power aₚₖ at the position pₖ of a first observation apparatus 10.

The learning unit 54 inputs the simulated radio wave strengths yₚₖ at the installation positions of the first observation apparatuses 10 to this prediction model in which the relation parameters are set, thereby calculating an estimate y_{P(x)} of the simulated radio wave strength at the target position.

Next, in step S42, the learning unit 54 calculates an error between the simulated radio wave strength at the target position calculated by the simulated radio wave strength calculation unit 43 in step S12 and the estimate of the simulated radio wave strength at the target position calculated by the learning unit 54 in step S41.

Next, in step S43, the learning unit 54 determines whether to end the learning of the fixed and varying relation parameters. The learning unit 54 advances the processing to step S45 when having determined to end the learning (Yes in step S43), or advances the processing to step S44 otherwise (No in step S43).

In step S44, the learning unit 54 updates the fixed and varying relation parameters based on the error calculated in step S42. Then, the learning unit 54 returns the processing to step S41.

In step S45, the re-learning unit 55 of the learning unit 54 applies the learned varying relation parameters (in this example, txₐₚ and aₚₖ) to the above modeling expression at the installation positions pk of the first observation apparatuses 10 to calculate estimates of the radio wave strengths at the first observation apparatuses 10.

In step S46, the re-learning unit 55 acquires the first observed radio wave strength data via the mode switching unit 42, and calculates an error between the first observed radio wave strength and the estimate of the radio wave strength of the first observation apparatus 10 calculated in step S45.

In step S47, the re-learning unit 55 determines whether to end the re-learning of the varying relation parameter. For example, the re-learning unit 55 may determine whether to end the re-learning by determining whether the error is smaller than a predetermined threshold. Further, the re-learning unit 55 may determine whether to end the re-learning by determining whether the number of updates has reached a predetermined number of times. The re-learning unit 55 ends the process when having determined to end the re-learning (Yes in step S47), or advances the processing to step S48 otherwise (No in step S47).

In step S48, the re-learning unit 55 updates the varying relation parameter based on the error calculated in step S46. Then, the learning unit 54 returns the processing to step S45.

Note that in this example, the prediction model used by the target radio wave strength calculation unit 46 in the “estimation mode” in the radio wave strength estimation process is expressed as an example as follows:

zₚ₍ₓ₎=txₐₚ−Σaₚ_{ₖ}b_{P(X),p}_{ₖ}D(P(x)),P(ap)) [Expression 7]

Here, txₐₚ and aₚₖ are the re-learned varying relation parameters, and b_{p(x), pk} is the learned fixed relation parameter.

Thus, in this third example embodiment, the radio wave strength estimation device 50 learns the fixed and varying relation parameters of the prediction model (in this example, txₐₚ, aₚₖ and b_{p(x), pk}) using the simulated radio wave strength at the installation position of each first observation apparatus 10 and the simulated radio wave strength at the target position. Then, the radio wave strength estimation device 50 re-learns the varying relation parameters (in this example, txₐₚ and aₚₖ) that are set for the target position in correspondence with each first observation apparatus 10 using the plurality of first observed radio wave strengths. This enables the radio wave strength estimation device 50 to appropriately adjust the varying relation parameter based on actually measured values, and further improve the accuracy of estimating a radio wave strength. Furthermore, this makes it possible to further improve the estimation accuracy of the position estimation process in the position estimator 80.

### Fourth Example Embodiment

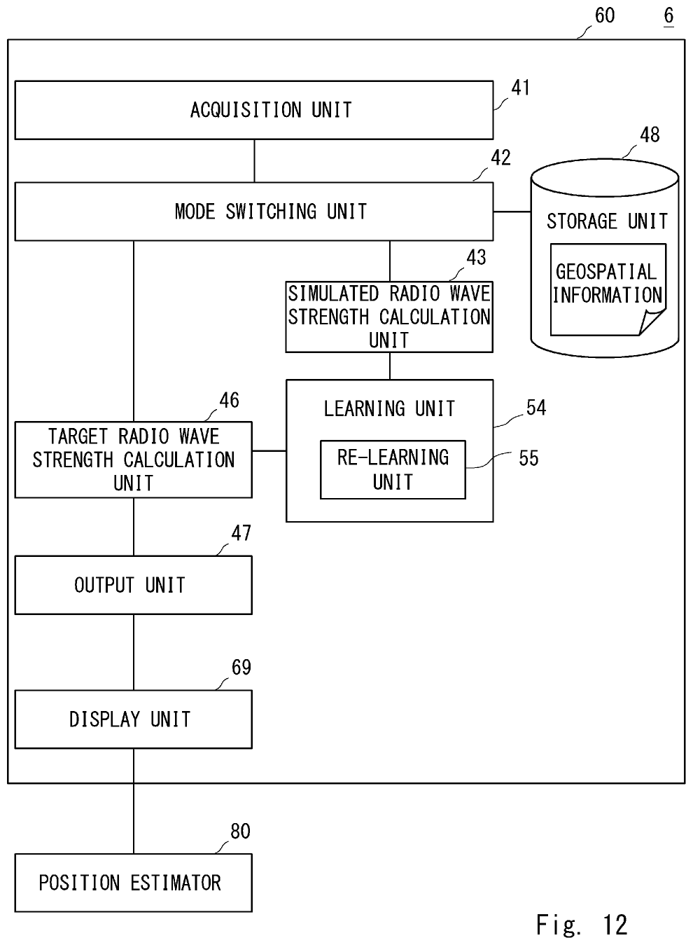

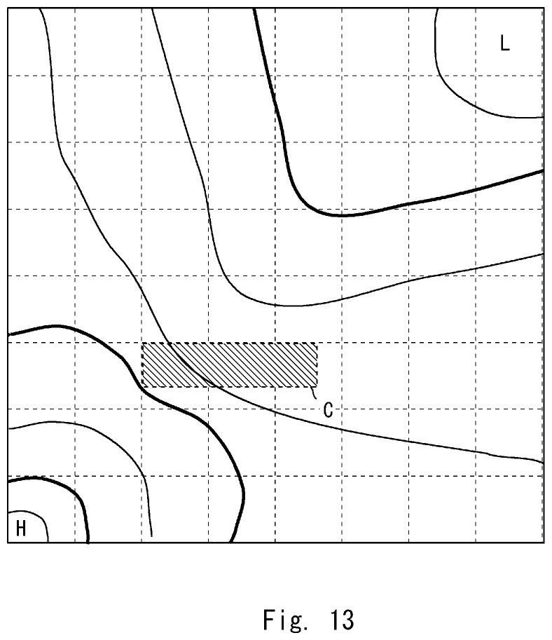

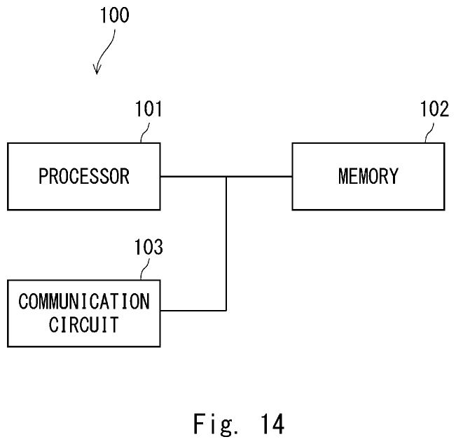

Next, a fourth example embodiment of the present disclosure will be described using FIGS. 12-13. The fourth example embodiment is characterized in that a position estimation apparatus visualize radio wave strengths in the target space. FIG. 12 is a block diagram showing an example configuration of a position estimation apparatus 6 according to the fourth example embodiment. The position estimation apparatus 6 according to the fourth example embodiment basically has the same configuration and function as those of the position estimation apparatus 5 according to the third example embodiment. However, the position estimation apparatus 6 according to the fourth example embodiment is different from the position estimation apparatus 5 according to the third example embodiment in that it includes a radio wave strength estimation device 60 instead of the radio wave strength estimation device 50.

The radio wave strength estimation device 60 has a display unit 69 in addition to the configuration of the radio wave strength estimation device 50.

The display unit 69 is a display that displays the radio wave strengths at the positions including the target position in the target space that are calculated by the target radio wave strength calculation unit 46 and output from the output unit 47.

FIG. 13 is a diagram showing an example of display on the display unit 69 of the radio wave strength estimation device 60 according to the fourth example embodiment. As shown in this figure, the display unit 69 may visualize the radio wave strengths in the target space by displaying the radio wave strength at each position in the target space using isometric lines of radio wave strengths. Note that in addition thereto, the display unit 69 may perform display based on the geospatial information as shown in this figure. For example, the display unit 69 may display, for example, the position and size of a structure in the target space.

Thus, according to this fourth example embodiment, the radio wave strength estimation device 60 calculates the radio wave strengths in the entire target space using the first observed radio wave strength data of the first observation apparatuses 10, the geospatial information, and the like and displays them for visualization. This can be used especially for visualizing the complicated situation of radio communication such as in a factory, a commercial facility, an event venue, or a stadium to grasp or improve the causes of radio disconnection or difficulty in radio connection in the area.

FIG. 14 is a schematic configuration diagram of a computer 100 according to the first to fourth example embodiments. In FIG. 14, the computer 100 has a processor 101, a memory 102, and a communication circuit 103. The processor 101 may be, for example, a microprocessor, an MPU (micro processing unit), or a CPU (central processing unit). The processor 101 may include a plurality of processors. The memory 102 is composed of a combination of a volatile memory and a non-volatile memory. The memory 102 may include a storage that is arranged separate from the processor 101. In this case, the processor 101 may access the memory 102 via an I/O interface not shown.

The position estimation apparatuses 4, 5, and 6 and the radio wave strength estimation devices 30, 40, 50, and 60 in the first to fourth example embodiments can have the hardware configuration of the computer 100 shown in FIG. 14. The learning processes, the position estimation processes, the radio wave strength estimation processes, and the like performed by the above apparatuses in the first to fourth example embodiments may be implemented by the processor 101 loading and executing a program stored in the memory 102. The acquisition units 31 and 41 may be implemented by the communication circuit 103. The program can be stored using various types of non-transitory computer readable media, and supplied to the computer 100. Examples of a non-transitory computer readable medium include a magnetic recording medium (e.g., a flexible disk, a magnetic tape, and a hard disk drive), and a photomagnetic recording medium (e.g., a magneto-optical disk). Furthermore, examples of a non-transitory computer readable medium include a CD-ROM (read only memory), a CD-R, and a CD-R/W. Furthermore, examples of a non-transitory computer readable medium include a semiconductor memory. Semiconductor memories include, for example, a mask ROM, a PROM (programmable ROM), an EPROM (erasable PROM), a flash ROM, and a RAM (random access memory). Further, the program may be supplied to the computer 100 via various types of transitory computer readable media. Examples of a transitory computer readable medium include an electric signal, an optical signal, and electromagnetic waves. A transitory computer readable medium can supply the program to the computer 100 via a wired communication path such as a wire and an optical fiber, or a radio communication path.

While the disclosure has been particularly shown and described with reference to embodiments thereof, the disclosure is not limited to these embodiments. It will be understood by those of ordinary skill in the art that various changes in form and details may be made therein without departing from the spirit and scope of the present disclosure as defined by the claims.

The first, second, third, and fourth embodiments can be combined as desirable by one of ordinary skill in the art.

The whole or part of the exemplary embodiments disclosed above can be described as, but not limited to, the following supplementary notes.

### (Supplementary Note 1)

A radio wave strength estimation device comprising:

an acquisition unit configured to, from each of a plurality of first observation apparatuses whose positions are known, acquire data on a first observed radio wave strength indicating a radio wave strength for a signal from a signal emission source that is received by each first observation apparatus;

a simulated radio wave strength calculation unit configured to calculate a simulated radio wave strength at each position in a target space for a simulation signal based on geospatial information on the target space using a theoretical model of radio wave propagation;

a learning unit configured to learn at least one relation parameter indicating relation between radio wave strengths at respective positions of the plurality of first observation apparatuses and a radio wave strength at a target position using the simulated radio wave strengths at the respective positions of the plurality of first observation apparatuses and the simulated radio wave strength at the target position; and

a target radio wave strength calculation unit configured to calculate a radio wave strength at the target position from the plurality of first observed radio wave strengths using the at least one learned relation parameter.

### (Supplementary Note 2)

The radio wave strength estimation device according to Supplementary note 1, wherein the geospatial information includes position information on a structure with respect to the signal emission source included in the target space.

### (Supplementary Note 3)

The radio wave strength estimation device according to Supplementary note 1 or 2, wherein the at least one relation parameter is expressed using radio wave strengths at the respective positions of two of the first observation apparatuses arranged at different positions and a radio wave strength at the target position.

### (Supplementary Note 4)

The radio wave strength estimation device according to any one of Supplementary notes 1 to 3, wherein

the at least one relation parameter includes a varying relation parameter that varies according to the plurality of first observed radio wave strengths, and

the radio wave strength estimation device further comprises a re-learning unit configured to re-learn the varying relation parameter included in the at least one learned relation parameter using the plurality of first observed radio wave strengths.

### (Supplementary Note 5)

The radio wave strength estimation device according to any one of Supplementary notes 1 to 4, further comprising a display unit configured to display the calculated radio wave strength at the target position.

### (Supplementary Note 6)

A position estimation system comprising:

a radio wave strength estimation device including: an acquisition unit configured to, from each of a plurality of first observation apparatuses whose positions are known, acquire data on a first observed radio wave strength indicating a radio wave strength for a signal from a signal emission source that is received by each first observation apparatus; a simulated radio wave strength calculation unit configured to calculate a simulated radio wave strength at each position in a target space for a simulation signal based on geospatial information on the target space using a theoretical model of radio wave propagation; a learning unit configured to learn at least one relation parameter indicating relation between radio wave strengths at respective positions of the plurality of first observation apparatuses and a radio wave strength at a target position using the simulated radio wave strengths at the respective positions of the plurality of first observation apparatuses and the simulated radio wave strength at the target position; and a target radio wave strength calculation unit configured to calculate a radio wave strength at the target position from the plurality of first observed radio wave strengths using the at least one learned relation parameter; and

a position estimator configured to acquire data on a second observed radio wave strength indicating a radio wave strength for a signal from the signal emission source that is received by a second observation apparatus whose position is unknown, and compare the second observed radio wave strength with the calculated radio wave strength at the target position to estimate the position of the second observation apparatus.

### (Supplementary Note 7)

The position estimation system according to Supplementary note 6, further comprising:

a plurality of first observation apparatuses whose positions are known; and

a second observation apparatus whose position is unknown.

### (Supplementary Note 8)

A radio wave strength estimation method comprising:

an acquisition step of, from each of a plurality of first observation apparatuses whose positions are known, acquiring data on a first observed radio wave strength indicating a radio wave strength for a signal from a signal emission source that is received by each first observation apparatus;

a simulated radio wave strength calculation step of calculating a simulated radio wave strength at each position in a target space for a simulation signal based on geospatial information on the target space using a theoretical model of radio wave propagation;

a learning step of learning at least one relation parameter indicating relation between radio wave strengths at respective positions of the plurality of first observation apparatuses and a radio wave strength at a target position using the simulated radio wave strengths at the respective positions of the plurality of first observation apparatuses and the simulated radio wave strength at the target position; and

a target radio wave strength calculation step of calculating a radio wave strength at the target position from the plurality of first observed radio wave strengths using the at least one learned relation parameter.

### (Supplementary Note 9)

A radio wave strength estimation program for causing a computer to execute:

an acquisition step of, from each of a plurality of first observation apparatuses whose positions are known, acquiring data on a first observed radio wave strength indicating a radio wave strength for a signal from a signal emission source that is received by each first observation apparatus;

a simulated radio wave strength calculation step of calculating a simulated radio wave strength at each position in a target space for a simulation signal based on geospatial information on the target space using a theoretical model of radio wave propagation;

a learning step of learning at least one relation parameter indicating relation between radio wave strengths at respective positions of the plurality of first observation apparatuses and a radio wave strength at a target position using the simulated radio wave strengths at the respective positions of the plurality of first observation apparatuses and the simulated radio wave strength at the target position; and

a target radio wave strength calculation step of calculating a radio wave strength at the target position from the plurality of first observed radio wave strengths using the at least one learned relation parameter.

The present disclosure can provide a radio wave strength estimation device, a position estimation system, and a radio wave strength estimation method that are capable of improving the accuracy of estimating a radio wave strength and improving the accuracy of estimating a position.

What is claimed is:

1. A radio wave strength estimation device comprising:
at least one memory configured to store instructions; and
at least one processor configured to execute the instructions,
wherein the processor is configured to:
from each of a plurality of first observation apparatuses whose positions are known, acquire data on a first observed radio wave strength indicating a radio wave strength for a signal from a signal emission source that is received by each first observation apparatus;
calculate a simulated radio wave strength at each position in a target space for a simulation signal based on geospatial information on the target space using a theoretical model of radio wave propagation;
learn at least one relation parameter indicating relation between radio wave strengths at respective positions of the plurality of first observation apparatuses and a radio wave strength at a target position using the simulated radio wave strengths at the respective positions of the plurality of first observation apparatuses and the simulated radio wave strength at the target position; and
calculate a radio wave strength at the target position from the plurality of first observed radio wave strengths using the at least one learned relation parameter.

2. The radio wave strength estimation device according to claim 1, wherein the geospatial information includes position information on a structure with respect to the signal emission source included in the target space.

3. The radio wave strength estimation device according to claim 1, wherein the at least one relation parameter is expressed using radio wave strengths at the respective positions of two of the first observation apparatuses arranged at different positions and a radio wave strength at the target position.

4. The radio wave strength estimation device according to claim 1, wherein
the at least one relation parameter includes a varying relation parameter that varies according to the plurality of first observed radio wave strengths, and
the processor is configured to re-learn the varying relation parameter included in the at least one learned relation parameter using the plurality of first observed radio wave strengths.

5. The radio wave strength estimation device according to claim 1, further comprising a display,
wherein the processor is configured to display the calculated radio wave strength at the target position on the display.

6. A position estimation system comprising:
a radio wave strength estimation device; and
a position estimator, wherein
the radio wave strength estimation device includes:
at least one first memory configured to store instructions; and
at least one first processor configured to execute the instructions,
the first processor is configured to:
from each of a plurality of first observation apparatuses whose positions are known, acquire data on a first observed radio wave strength indicating a radio wave strength for a signal from a signal emission source that is received by each first observation apparatus;
calculate a simulated radio wave strength at each position in a target space for a simulation signal based on geospatial information on the target space using a theoretical model of radio wave propagation;
learn at least one relation parameter indicating relation between radio wave strengths at respective positions of the plurality of first observation apparatuses and a radio wave strength at a target position using the simulated radio wave strengths at the respective positions of the plurality of first observation apparatuses and the simulated radio wave strength at the target position; and
calculate a radio wave strength at the target position from the plurality of first observed radio wave strengths using the at least one learned relation parameter,
the position estimator includes:
at least one second memory configured to store instructions; and
at least one second processor configured to execute the instructions, and
the second processor is configured to acquire data on a second observed radio wave strength indicating a radio wave strength for a signal from the signal emission source that is received by a second observation apparatus whose position is unknown, and compare the second observed radio wave strength with the calculated radio wave strength at the target position to estimate the position of the second observation apparatus.

7. The position estimation system according to claim 6, further comprising:
a plurality of first observation apparatuses whose positions are known; and
a second observation apparatus whose position is unknown.

8. A radio wave strength estimation method comprising:
a step of, from each of a plurality of first observation apparatuses whose positions are known, acquiring data on a first observed radio wave strength indicating a radio wave strength for a signal from a signal emission source that is received by each first observation apparatus;
a step of calculating a simulated radio wave strength at each position in a target space for a simulation signal based on geospatial information on the target space using a theoretical model of radio wave propagation;
a step of learning at least one relation parameter indicating relation between radio wave strengths at respective positions of the plurality of first observation apparatuses and a radio wave strength at a target position using the simulated radio wave strengths at the respective positions of the plurality of first observation apparatuses and the simulated radio wave strength at the target position; and
a step of calculating a radio wave strength at the target position from the plurality of first observed radio wave strengths using the at least one learned relation parameter.
